(19) United States
(12) Patent Application Publication
(10) Pub. No.: US 2016/0019720 A1
(43) Pub. Date: Jan. 21, 2016

(54) Method for Viewing Two-Dimensional Content for Virtual Reality Applications

(71) Applicant: Ion Virtual Technology Corporation, Boise, ID (US)

(72) Inventors: Daniel Thurber, Boise, ID (US); Jorrit Jongma, Geldrop (NL)

(73) Assignee: ION VIRTUAL TECHNOLOGY CORPORATION, Boise, ID (US)

(21) Appl. No.: 14/799,245

(22) Filed: Jul. 14, 2015

Related U.S. Application Data
(60) Provisional application No. 62/024,861, filed on Jul. 15, 2014.

(51) Int. Cl. G06T 19/00; G02B 27/01

(52) U.S. Cl. CPC G06T 19/006; G02B 27/0172; G02B 2027/0178

(57) ABSTRACT

A virtual reality or augmented reality system comprises first and second displays, lenses, access to computing components, and software for evaluating a selected two-dimensional video, generating a first content and a second content based on the original two-dimensional video and observed characteristics of the two-dimensional video, determining a time delay based on characteristics of the two-dimensional video, and displaying the first content on a first display at a first time and the second content on the second display at a second time. The first content and second content can be generated entirely before displaying on first and second displays or it can be generated dynamically while being displayed. Additionally, the video can be displayed unaltered with only a time delay between the first and second displays depending on the observed characteristics of the two-dimensional video.

### CROSS-REFERENCE TO RELATED APPLICATIONS

This application claims the benefit of co-pending provisional U.S. Application No. 62/024,861, filed Jul. 15, 2014.

### FIELD OF INVENTION

This invention relates to virtual reality and augmented reality environments and display systems. More particularly, this invention relates to a method of viewing two-dimensional video content so that it appears as three-dimensional content using a virtual reality or augmented reality headset system.

### BACKGROUND

Virtual reality (VR) and augmented reality (AR) systems are gaining in popularity and providing useful for many applications including gaming, entertainment, advertising, architecture and design, medical, sports, aviation, tactical, engineering, and military applications. Most VR systems use personal computers with powerful graphics cards to run software and display the graphics necessary for enjoying an advanced virtual environment. To display virtual reality environments, many systems use head-mounted displays (HMDs).

Many HMDs include two separate and distinct displays, one for each eye, to create a stereoscopic effect and give the illusion of depth. HMDs also can include on-board processing and operating systems such as Android to allow application to run locally, which eliminates any need for physical tethering to an external device. Sophisticated HMDs incorporate positioning systems that track the user's head position and angle to allow a user to virtually look around a VR or AR environment simply by moving his head. Sophisticated HMDs may also track eye movement and hand movement to bring additional details to attention and allow natural interactions with the VR or AR environment.

While traditional HMDs include dedicated components, interest is growing to develop an HMD that incorporates a user's own mobile device such as smart phones, tablets, and other portable or mobile devices having video displays. In order to create an immersive VR environment, however, the single traditional display on the mobile device must be converted to a stereoscopic display. Accordingly, it would be desirable to provide an HMD or VR headset that cooperates with a mobile device and to provide a method for converting the traditional single display into a stereoscopic display.

Additionally, interest is growing to develop a method of watching traditional and widely available two-dimensional content as three-dimensional content. Users of traditional VR or AR systems, traditional VR or AR headset systems, and VR or AR headset systems that incorporate mobile devices all would benefit from the ability to watch currently available two-dimensional content and experience it as three-dimensional content. In particular, it would be desirable to watch a two-dimensional video and experience it as a three-dimensional video. Accordingly, it would be desirable to provide a method for converting and viewing two-dimensional content so that it can be experienced as three-dimensional content with virtual reality or augmented reality systems.

### SUMMARY OF THE INVENTION

A virtual reality (VR) or augmented reality (AR) system comprises one or more displays, one or more lenses, and access to computing components for executing a method of displaying two-dimensional content so that a user of the VR or AR system experiences it as three-dimensional content for virtual reality or augmented reality applications and environments. A VR or AR headset system optionally further comprises a head mounted display or a head mounted display frame that accommodates a mobile device. Where the VR or AR system or headset system comprises only one display, the display is converted by executing software stored remotely or locally to generate two adjacent smaller displays. Using adjacent first and second displays, two-dimensional (2D) content such as a video available over the Internet is accessed for independent display on the first display and the second display. The first display is viewable through a first lens, and the second display is viewable through a second lens. First and second lenses can be sections of a single lens where only a single lens is used. First and second lenses are viewed simultaneously by a user of the VR or AR system by positioning a first eye so that it cooperates with the first lens and a second eye so that it cooperates with the second lens. A user selects a video to watch with his VR or AR system. The video may be stored locally on the VR or AR system or remotely and accessed via a network, wired connection, or other communication link. By executing software stored remotely or locally on the VR or AR system, the video is accessed, evaluated, altered to generate first content and second content where desirable, and made available for display on the first display and for independent display on the second display. The generated first content is displayed beginning at a first time on the first display, and the generated second content is displayed beginning at a second time on the second display. The first content and the second content can be generated entirely before the content is displayed on the respective first and second displays or it can be dynamically adjusted as it is being displayed. Alternatively, where alteration of the 2D video is not desirable, the original 2D video can be displayed on the first display at a first time and on the second display at a second time where difference between the first time and the second time is determined based on characteristics of the 2D video. For example, the video may be displayed at a given time (T) on the first display and at a given time plus a delay (T+X) on the second display.

### BRIEF DESCRIPTION OF THE DRAWINGS

FIG. 1 is an illustration of the components of a VR headset system that incorporates a mobile device and optionally accesses a media store via a network.

FIG. 2 is a flow chart of a method of converting a traditional mobile device display into two adjacent displays according to the present invention.

FIG. 3 is a flow chart of the method of displaying two-dimensional content to create a three-dimensional environment according to the present invention.

FIG. 4A is a flow chart of the video analysis program that is part of the method of displaying two-dimensional content to create a three-dimensional environment according to the present invention

FIG. 4B is a flow chart of an alternative embodiment of the video analysis program that is part of the method of displaying two-dimensional content to create a three-dimensional environment according to the present invention.

FIG. 5 is a flow chart of an embodiment of the method of displaying two-dimensional content to create a three-dimensional environment according to the present invention.

FIG. 6 is a flow chart of an embodiment of the alternative embodiment of the video analysis program that is part of the method of displaying two-dimensional content to create a three-dimensional environment illustrated in FIG. 5.

### DETAILED DESCRIPTION OF THE INVENTION

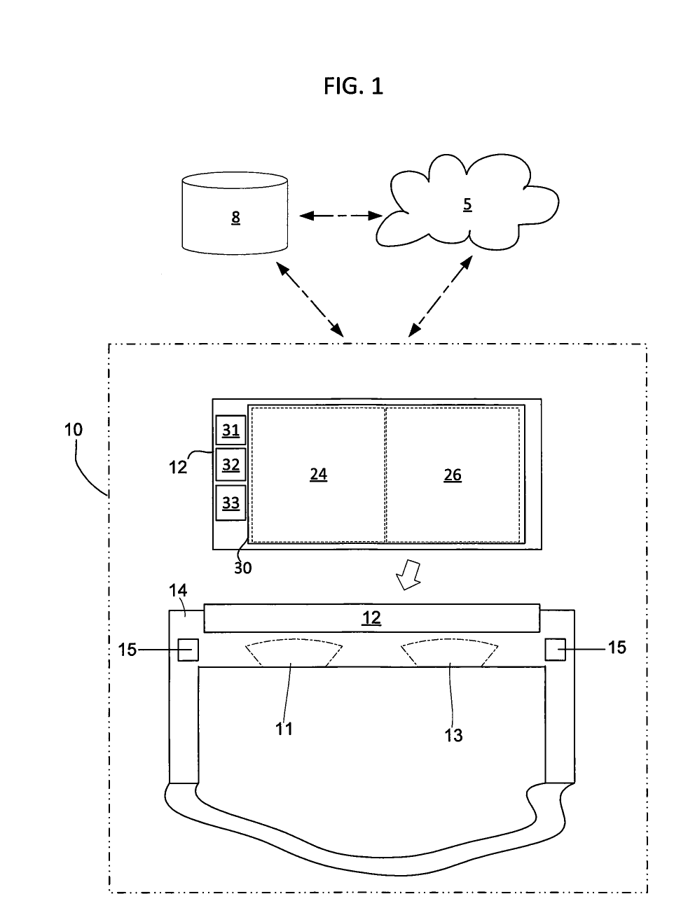

As shown in FIG. 1, a virtual reality (VR) headset system 10 comprises a head mounted display (HMD) frame 14, lenses 11 and 13, control and processing components 15, a mobile device 12 having a display 30, and access to computing components for executing a method of converting the traditional mobile device display into adjacent first and second displays where necessary and for executing a method of displaying two-dimensional content to create a three-dimensional virtual reality environment. Alternatively, VR headset system 10 may comprise fewer or additional components of a traditional HMD and also may comprise one or more integral and dedicated displays rather than cooperating with a mobile device. VR headset system 10 may be a standard VR system that is not worn as a headset as well. For example, the VR system may be a display system tethered to a traditional personal computer or gaming system. Further, for simplicity, VR system and VR headset system as used herein includes AR systems and AR headset systems as well. Displays can be any type of display including but not limited light-emitting diode displays, electroluminescent displays, electronic paper or E ink displays, plasma displays, liquid crystal displays, high performance addressing displays, thin-film transistor displays, transparent displays, organic light-emitting diode displays, surface-conduction electron-emitter displays, interferometric modulator displays, carbon nanotube displays, quantum dot displays, metamaterial displays, swept-volume displays, varifocal mirror displays, emissive volume displays, laser displays, holographic displays, light filed displays, virtual displays, or any other type of output device that is capable of providing information in a visual form.

The HMD frame 14 preferably houses or attaches to lenses 11 and 13 and houses or attaches to a computer such as control and processing components 15. Frame can be any type of headwear suitable for positioning attached lenses near the user's eyes as is well known in the art. Lenses can be any type of lenses suitable for viewing displays at a very close distance as is also well known in the art. For example, lenses with a 5× or 6× magnification are suitable. Lenses can also include or be attached to or adjacent to hardware that can be used to record data about the displayed content on the first and the second displays that can be used for further evaluation and for generating first and second content. Control and processing components 15 comprise any components such as discrete circuits desirable or necessary to use the headset for a virtual reality experience and to cooperate with mobile device 12. For example, control and processing components 15 may include control circuitry, input devices, sensors, and wireless communication components. In a further form, the control and processing components include additional computing components such as a processor programmed to operate in various modes and additional elements of a computer system such as, memory, storage, an input/output interface, a communication interface, and a bus, as is well known in the art.

FIG. 1 also illustrates how mobile device 12 physically cooperates with HMD frame 14. HMD frame 14 preferably attaches to or alternatively is positioned adjacent to one side of mobile device 12 such that a user can view the display 30 of mobile device 12 when looking through lenses 11 and 13. Mobile device 12 preferably is hand-held and includes typical components of a hand-held mobile device such as a display 30 that forms a surface of the mobile device and a computer. The mobile device computer comprises a processor 31, memory 32, wireless and/or wired communication components 33, and an operating system, and it can run various types of application software as is well known in the art. Mobile device 12 generally includes any personal electronic device or any mobile or handheld device that has a screen, display, or other optical or optometrical component including but not limited to mobile phones, cellular phones, smartphones, tablets, computers, dedicated displays, navigation devices, cameras, e-readers, personal digital assistants, and optical or optometrical instruments. Mobile devices displays including mobile dedicated displays can be any type of display including but not limited to light-emitting diode displays, electroluminescent displays, electronic paper or E ink displays, plasma displays, liquid crystal displays, high performance addressing displays, thin-film transistor displays, transparent displays, organic light-emitting diode displays, surface-conduction electron-emitter displays, interferometric modulator displays, carbon nanotube displays, quantum dot displays, metamaterial displays, swept-volume displays, varifocal mirror displays, emissive volume displays, laser displays, holographic displays, light filed displays, virtual displays, or any other type of output device that is capable of providing information in a visual form. Optionally and preferably, especially for a mobile device that is a dedicated display, the mobile device further comprises a high-definition multimedia interface (HDMI) port, a universal serial device (USB) port, or other port or connection means to facilitate direct or wireless connection with a computing device or larger display device such as a television. Alternatively, mobile device can be an optical or optometrical instrument useful for configuring the headset for a particular user. For example, mobile device can be a pupillometer that measures pupillary distance or pupil response and provides guidance for making adjustments to the headset components or for automatically adjusting the headset components.

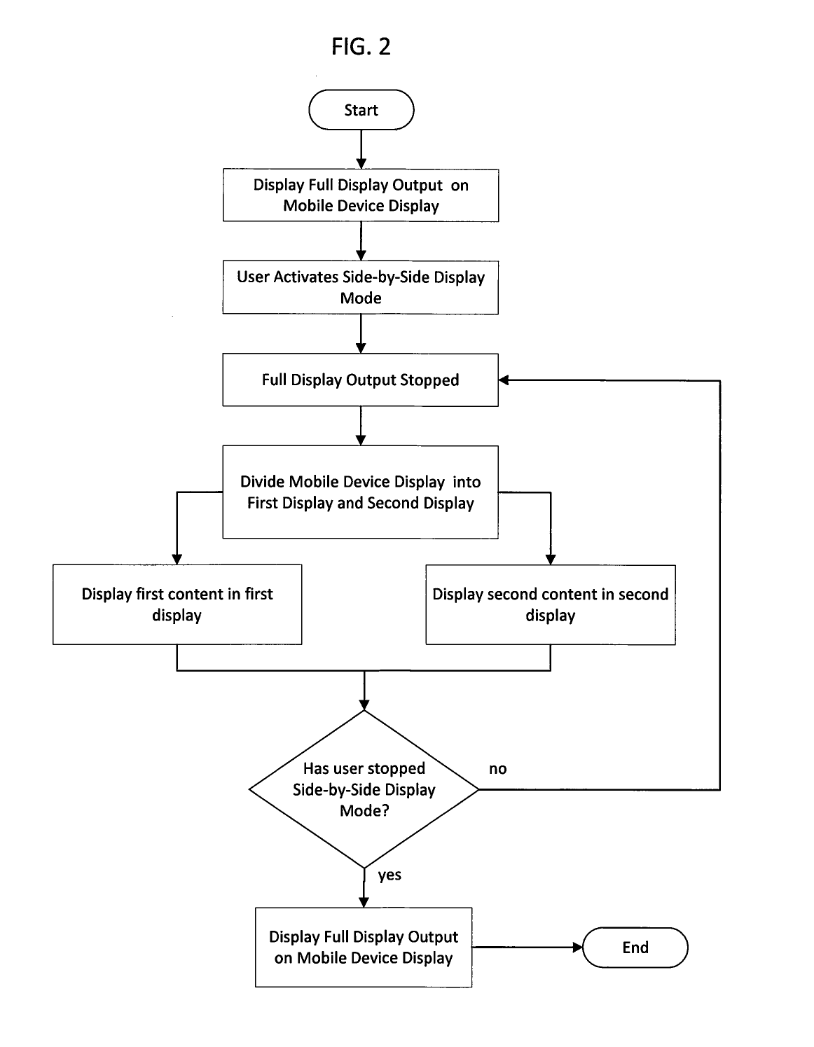

Optionally and preferably, mobile device 12 comprises display conversion code or software that is stored on the memory and executable by the processor to convert the traditional mobile device display to adjacent first and second displays. Alternatively, mobile device 12 can access through a wireless or wired communication link or over a network display conversion software that is stored remotely. FIG. 2 illustrates one embodiment of conversion software useful for converting the single display of a mobile device into adjacent first and second displays. As shown, a user activates a side-by-side display mode, either by selecting it with physical switch or button, by selecting it through a graphical user interface (GUI), or by simply inserting his mobile device into HMD frame 10. Where the user selects the side-by-side display mode by placing his mobile device in HMD frame 10, sensors or switches recognize proper placement of mobile device 12 in HMD frame 10 as is known to those skilled in the art and activate side-by-side display mode accordingly. Once side-by-side display mode has been activated, the traditional display full output is stopped. The side-by-side displays comprises a first display or left display 24 and a second display or right display 26. First display 24 and second display 26 can be sized so that they comprise the entire original display size of the mobile device or they can be sized so that they only comprise a portion of the original display size of the mobile device. First and second displays 24 and 26 can play the same content or output or they can display different content or output. Additionally, first and second displays 24 and 26 can simultaneously display the same or different content. Where VR headset system 10 comprises an integral or dedicated display rather than cooperating with a mobile device, the display can similarly be either independent first and second displays 24 and 26 or it can be a single display 30 that is divided with conversion software as described with respect to the mobile device display into first and second displays 24 and 26.

FIG. 1 also illustrates how the VR headset system 10 can be connected through a network 5 to a remotely located media store 8 having one or more media files such as two-dimensional (2D) video files. Network 5 can be a local network, a private network, or a public network. Media store 8 can be part of the memory 32 of the mobile device where a media file is stored or memory of the HMD control and processing components 15 where a media file is stored. Alternatively, media store can be media files stored at a remotely located media storage location that is accessed through the Internet or it can be media files stored on portable and removable media storage such as a flash drive.

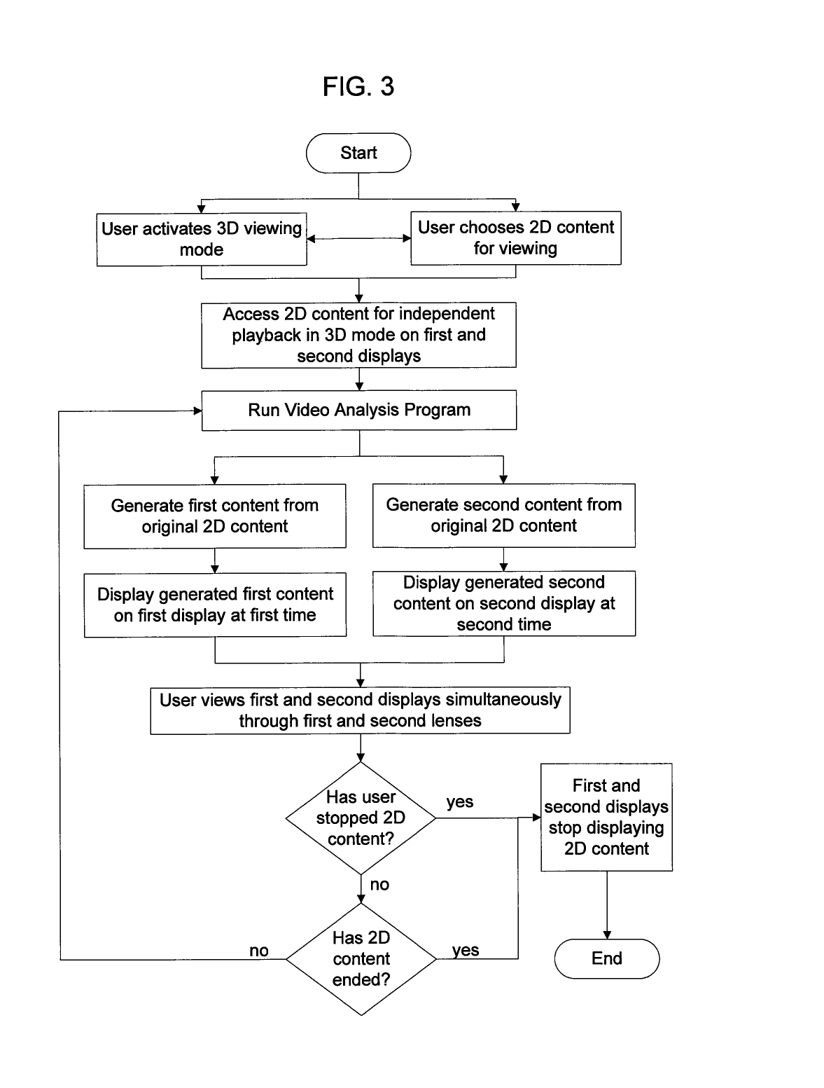

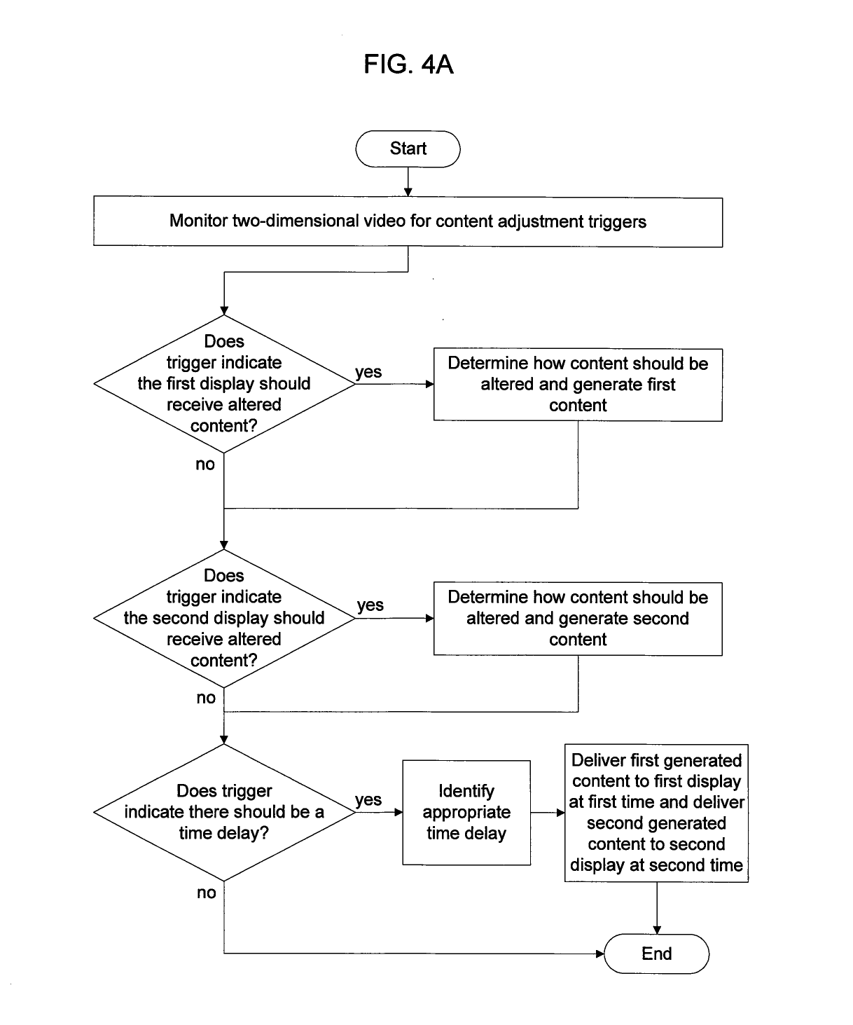

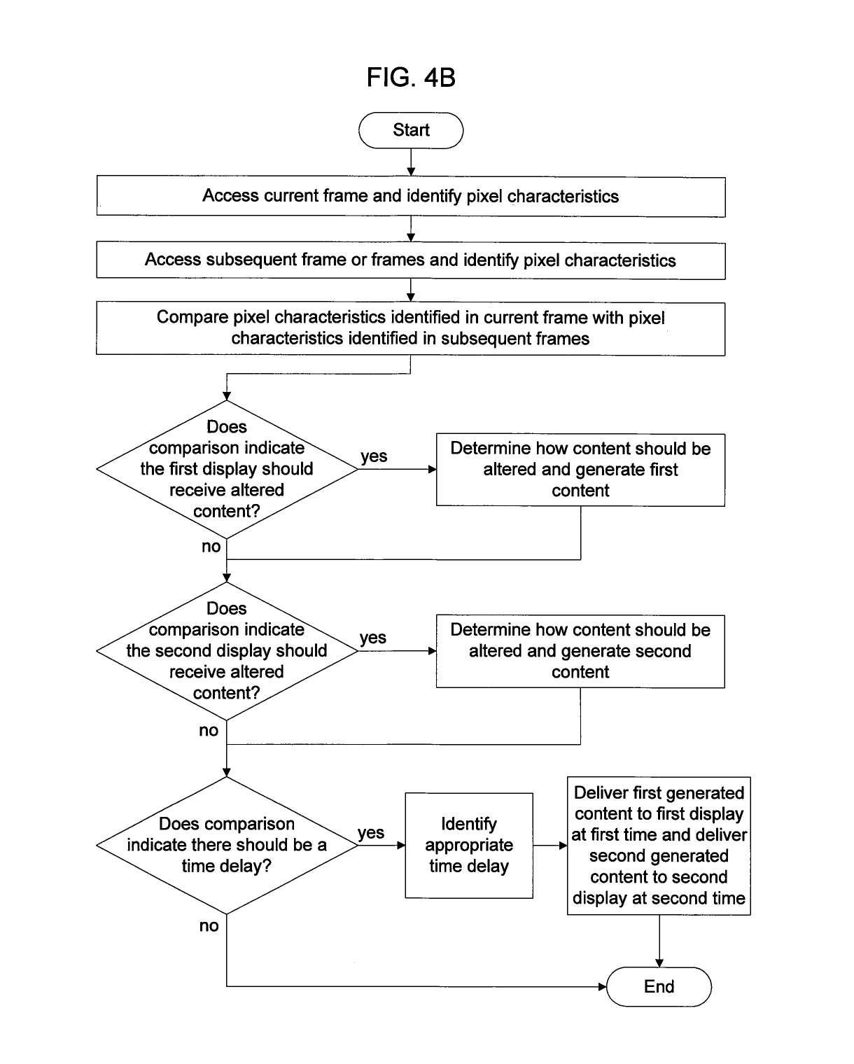

FIGS. 3 and 4 illustrate how the selected 2D content is examined and altered for playback on the first and second displays of the headset system 10 according to the method of displaying two-dimensional content to create a three-dimensional environment of the present invention that is useful in virtual reality or augmented reality environments and applications. In general, software for examining or analyzing the 2D content, for altering the content, and for delivering the content to the first and second displays is stored in the memory of and executed with the processor of local or remote computing components or control and processing components such as the control and processing components 15 of the HMD frame, the computing components 31, 32 of the mobile device 12, or additional computing components housed in the VR headset system 10 or accessible through a wired, wireless, or network connection. Computing components or control and processing components preferably include a processor, memory, and wireless or wired communication components as is well known in the art. The processor can be configured to perform any suitable function and can be connected to any component in the VR headset system. The memory may include one or more storage mediums, including for example, a hard-drive, cache, flash memory, permanent memory such as read only memory, semi-permanent memory such as random access memory, any suitable type of storage component, or any combination thereof. The communication components can be wireless or wired and include communications circuitry for communicating with one or more servers or other devices using any suitable communications protocol. For example, communication circuitry can support Wi-Fi, Ethernet, Bluetooth® (trademark owned by Bluetooth Sig, Inc.), high frequency systems such as 900 MHz, 2.4 GHz, and 5.6 GHz communication systems, infrared, TCP/IP, HTTP, BitTorrent, FTP, RTP, RTSP, SSH, any other protocol, or any combination thereof. Communication circuitry may also include an antenna for transmitting and receiving electromagnetic signals.

FIG. 3 illustrates the method of accessing 2D content and playing it back in an altered or transformed form substantially simultaneously on first and second displays of the headset system 10 according to the method of displaying two-dimensional content to create a three-dimensional environment of the present invention. First a user activates a 3D viewing mode and then selects 2D content for viewing. Alternatively, the user selects 2D content for viewing and then activates a 3D viewing mode. To activate the 3D viewing mode, a user either selects 3D viewing mode by using a physical switch or button, by selecting the option on a graphical user interface (GUI), or by simply inserting his mobile device into the HMD frame 14 if a VR headset system for mobile devices is being used. Where the user selects 3D viewing mode by placing his mobile device in HMD frame 14, sensors or switches recognize proper placement of mobile device 12 in HMD frame 14 as is known to those skilled in the art and activate 3D viewing mode accordingly.

Once 3D viewing mode has been activated or alternatively prior to activating the 3D viewing mode, the user can select the two-dimensional content he wishes to view. For example, the user can select a video for viewing and, if necessary, access it using a wired or wireless communication link. The video could be streamed from a free source or from a subscription Website, it could be downloaded to and stored on the user's computer or mobile device, or it could be available on DVD, flash memory, or some other storage medium.

Activating 3D viewing mode triggers a 2D conversion software program to analyze the original 2D content with a video analysis program and then to generate new first and second content for display on the first and second displays at first and second times, respectively, as shown in FIG. 3. The original 2D content is evaluated preferably with the video analysis program illustrated in FIG. 4 and described below. Depending on the outcome of the video analysis program, the original 2D content is converted, transformed, or altered to generate a first content and a second content. Each of the generated first and second contents may be the same as the original content, interpolated from individual frames of the original content such as with motion interpolation or motion-compensated frame interpolation, partially interpolated from the individual frames of the original content, partial frames of the original content, brighter or dimmer than the original content, have higher or lower contrast than the original content, be, or be otherwise modified so that it is no longer identical to the original 2D content. Additionally, the newly generated first content and the newly generated second content can be independently altered and generated such that the first content may differ from the original content in one manner while the second content may differ from the original content in another manner. Once the first content and second content have been generated, they can be delivered to and displayed on the first and second displays respectively either simultaneously, substantially simultaneously, or with a predetermined or calculated time delay. The user is then able to view the first and second displays simultaneously through the first and second lenses of the VR system. The 2D video continues to be delivered as newly generated first content and second content on the first display and the second display until the video ends or until the user affirmatively stops the video playback.

The selected 2D video content is preferably analyzed with the video analysis program illustrated in FIGS. 4A and 4B. The selected 2D video content can be analyzed entirely in advance of or before generating new first and second contents, it can be analyzed as the new content is being generated, or it can be analyzed in segments and then generate the new first and second contents in segments. Preferably, the selected 2D content is being analyzed and new content is being generated during playback in either fixed time intervals or in an asynchronous, or without fixed time intervals, fashion. For example, after a first part it is analyzed and a new first and second content for the first part is generated and as the new first content and second content is delivered to and displayed on the first and second displays, the next part of the 2D content is being analyzed and new first and second content generated. This continues until the entire 2D content has been analyzed and new first and second content has been generated or until the user affirmatively stops the process. Preferably, the original 2D video content is analyzed or evaluated to identify content adjustment triggers that indicate, instruct, or suggest that new content should be generated for ultimate delivery to one or both displays and/or that indicate, instruct, or suggest that the content should be displayed at different times. More preferably, the 2D video content is analyzed or evaluated to identify movement in the video. Specifically, it is evaluated to identify camera panning, objects moving, actors moving, or any other indication of movement. The movement may be to the left, to the right, forward, backward, up, or down.

One embodiment of how to monitor, analyze, or evaluate the 2D video content for characteristics suggesting movement is illustrated in FIG. 4B where preferably the pixels of the 2D video are monitored to count pixel movement. The color of each individual pixel is determined as they refresh to recognize movement to the left, to the right, up, down, or in any combination. For example, where a black ball is moving against a white static background, the number and the location of the black and white pixels are noted. After the pixels refresh, the number and location of the black and white pixels are noted again. Then, the number and location of the black and white pixels from the initial moment are compared to the number and location of the black and white pixels of the moment after refresh to determine if there was any change and where there was change if it represented movement in a certain direction.

While movement is one trigger that can be monitored in the 2D content, it does not have to be the trigger that is monitored or it can be monitored in addition to monitoring for other triggers. In other embodiments, the video can be analyzed for certain markers unintentionally or deliberately included in the video to trigger certain content changes. For example, a content author or video producer may intend for his 2D video to be viewable using the method described herein and may include instructions embedded in the video that can be monitored by the video analysis program to trigger various delays or interpolations of the content delivery. Similarly, a third party may provide instructions or triggers or even entire new first and second contents that can be accessed by users of system 10. For example, separate instructions or triggers may be available as a small file available for download or delivered as a companion stream to the video rather than in the original 2D video file or stream itself.

Once the change in pixel characteristics or other triggers are found that suggest movement or other reasons for altering the 2D video content, the comparison, change, or trigger is evaluated to determine if a new first content should be generated, a new second content should be generated, or a time delay between display of the first content and display of the second content should be introduced. Where the trigger indicates that the first display should receive altered content, how the content should be altered is determined and the first content is generated. Where the trigger indicates that the second display should receive altered content, how the content should be altered is determined and the second content is generated. Where the trigger indicates that both the first display and the second displays should receive altered content, then how the content should be altered for display on the first display is determined, the first content is generated, how the content should be altered for display on the second display is determined, and the second content is generated. Where the trigger indicates that an additional time delay or lag should be present between when the first content is delivered to the first display and the second content should be delivered to the second display, then the appropriate time delay is identified. The time delay can be for the first content on the first display or for the second content on the second display.

The time delay can be defined in any way one describes time relationships and can be an additional specified time delay or it can simply result from altering the 2D content from its original form to the generated first and second contents such as by interpolating frames or similar changes. For illustrative purposes, the time delay is characterized herein as a time delay of X. In one embodiment, time delay X can be defined by the number of frames that would display during the time delay. For example, X can be a 1 frame delay, which for a video that plays 24 frames per second (fps), is equal to a delay of approximately 42 milliseconds. Preferably, where the video is 24 fps, the delay is preferably only 1 frame or approximately 42 milliseconds. Where the video is 60 fps, the delay is preferably 1 or 2 frames or approximately 17 to 33 milliseconds. Alternatively, the delay can be equal to only a fraction of a frame such as where X is a ½ frame delay, which for a video that plays 24 fps, the delay would be 21 milliseconds. Another way to define the display delay from the first display to the second display is to consider the displays as beginning playback of the video from a particular point in the video. For example, the first display starts the video at the 100th frame and the second display starts the video simultaneously but at the 100th frame—X where X is the number of frames associated with a delay. For a 24 fps video, the first display would start at the 100th frame and the second display would simultaneously start at the 99th frame. An additional alternative for measuring the delay from the first display's output to the second display's output is to measure it in terms of the screens' refresh rates. The screen may refresh multiple times per second, but the refresh of each screen should not be synchronized. Accordingly, the second display's output should be slightly delayed from the first display's output by refreshing the display at different intervals or different times.

Further, for illustrative purposes, the delivery of the first content to the first display occurs at time T and the delivery of the second content to the second display occurs at time T+X, where X is the time delay as discussed above. When the first content is to start to be displayed on the first display ahead of when the second content is to start to be displayed on the second display, then X is a positive number. Where the first content is to start to be displayed on the first display after the second content is to start to be displayed on the second display, then X is a negative number. In addition to being a positive or negative number, X can also be a fraction or a whole number. For example, first content may begin to be displayed on first display at 50 seconds, and second content may begin to be displayed on second display at 50.5 seconds where the delay is ½ of a second. Alternatively, where no delay should be present, then X can be set to equal zero.

The video analysis program continues to run and evaluate continuously as the 2D content is played where it is configured to run substantially simultaneously with content delivery to the user. Then, once the user has stopped the delivery of the altered 2D content or the altered 2D content has concluded, the analysis program ends. Where the video analysis program evaluates the entire 2D video content before delivering the content to the user, once the video analysis program has generated new first content and new second content for the length of the entire 2D video content, it delivers the generated first content to the first display at a first time, and it delivers the generated second content to the second display at a second time accordingly.

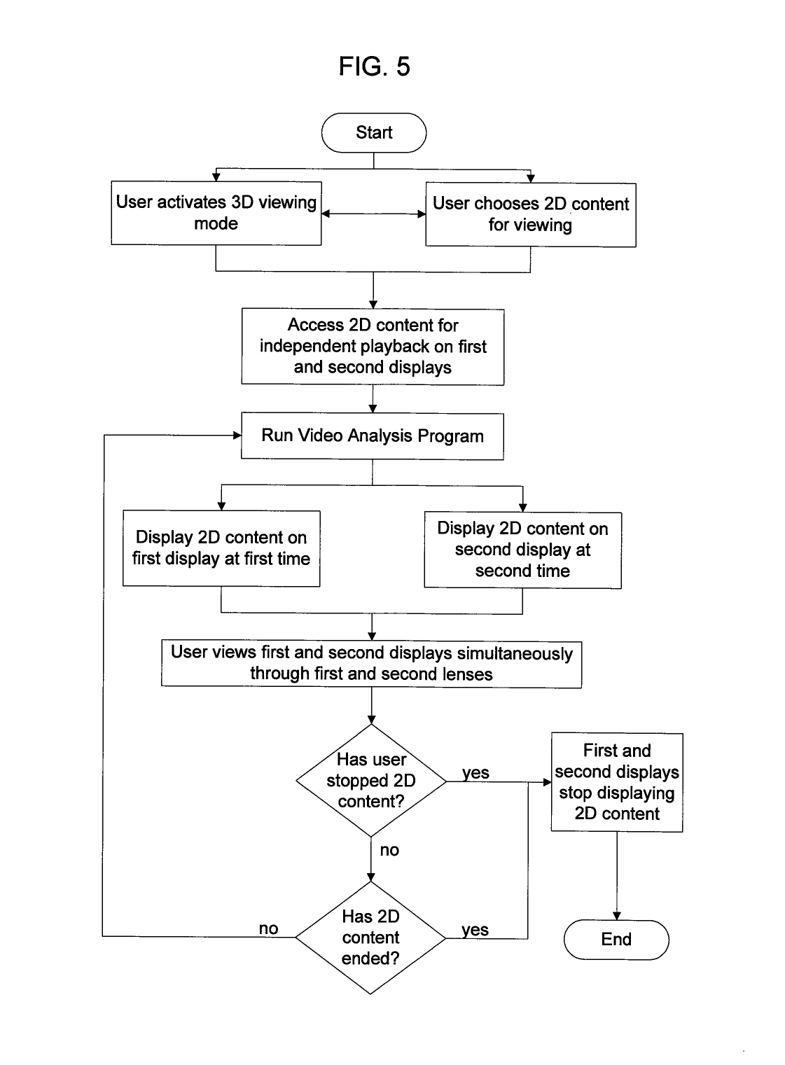

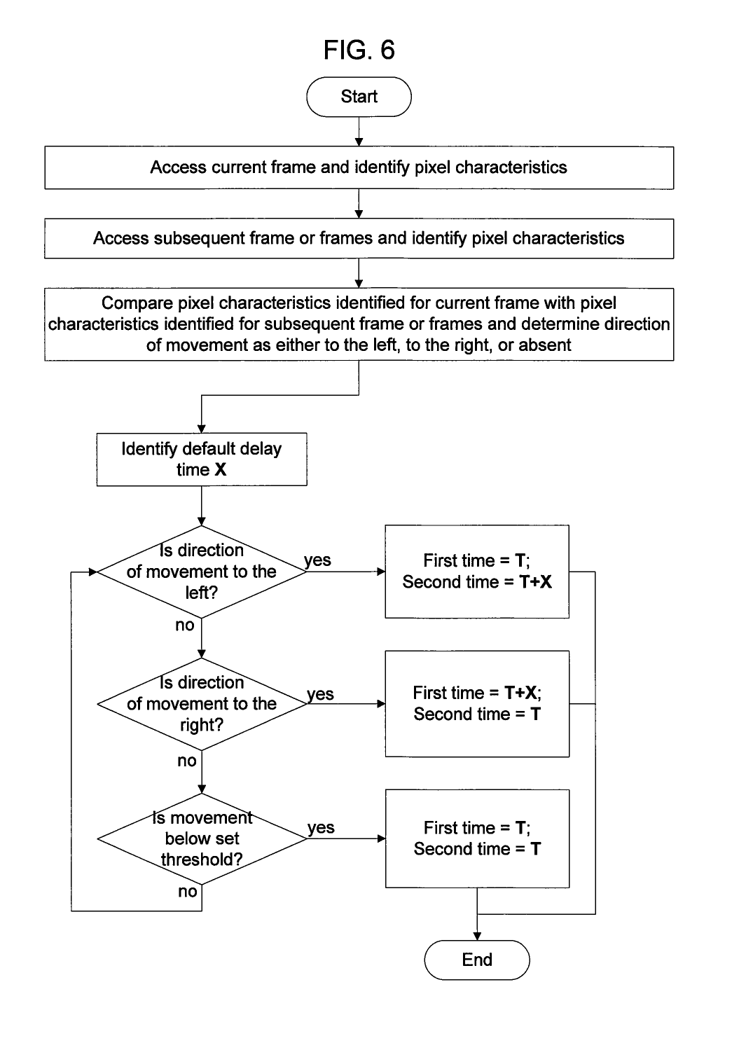

FIGS. 5 and 6 illustrate an additional embodiment of the present invention where the first content and second content are each identical to the original 2D video content and their delivery to the first and second displays viewed by the user only differs in that one is displayed beginning at a first time and the other is being displayed at a second time. Whether the first time is delayed or the second time is delayed is determined based on whether movement to the left or right has been identified. Preferably movement is identified by examining the change in pixel characteristics such as number, location, and color from frame to frame. Further, in a preferred embodiment and as shown in FIG. 6, when movement is identified as movement to the left, then the first time is set to T while the second time is set to T+X. When movement is identified as movement to the right, then the first time is set to T+X and the second time is set to T. When movement is nonexistent or determined to be less than a given threshold, then X is 0 and both the first time and the second time are set to T. As discussed earlier with respect to FIG. 4A, X can be a positive number, negative number, fraction, whole number, or equal to zero.

With this method, the content delivered to the user is dynamically adjusted according to whether the two-dimensional content reflects left or right movement and where the delay is minimized or eliminated when the content should be synced. For example, if the selected video was created by a camera panning right, then the delay between screen delays would be adjusted so that display with delayed content is viewed with the user's left eye. Conversely, if the selected video was created by a camera panning left, then the delay between screen delays would be adjusted so the display with delayed content is viewed with the user's right eye. Alternatively, if the selected video had segments where a single image, such as an entirely black screen, is displayed, then the delay between screen delays would be minimized or preferably eliminated. Similarly, where the selected video had segments with minimal movement or movement less than a defined amount, the delay between screen delays would be minimized or preferably eliminated. In other embodiments, other parameters can be defined as well to determine whether the delay should be delivered to the user's left or right eye. In some cases, when the camera pans to the right, it may be preferable to display the delayed content for the user's right eye, and when the camera pans to the left, it may be preferably to display the delayed content for the user's left eye. In yet another embodiment, it may be desirable to determine which display shows delayed content based on if an object or actor is moving in the video rather than if the camera is panning. For example, if the backdrop is static and an actor shown in the video is moving to the left, the display could be adjusted based on the actor's movement.

While left or right movement is discussed with respect to the embodiment illustrated in FIGS. 5 and 6, that embodiment can also be used to adjust content delivered to two displays viewed by a user where the content is altered or generated in response to other characteristics as well. For example, vertical movement, or up and down movement, may also be considered and the content delivered to the first and right displays may be adjusted according to predetermined parameters. Additionally movement of objects or actors in combination with camera panning or other factors can trigger changes in the content delivered. Any detectible movement or change in the 2D video can be trigger a change in the content delivery time between the first and second displays.

While there has been illustrated and described what is at present considered to be the preferred embodiment of the present invention, it will be understood by those skilled in the art that various changes and modifications may be made and equivalents may be substituted for elements thereof without departing from the true scope of the invention disclosed, but that the invention will include all embodiments falling within the scope of the claims.

We claim:

1. A system useful for viewing two-dimensional content so that it appears to a user as three-dimensional content, the system comprising:
a. a headset system comprising a first display and a second display;
b. a media store containing at least one two-dimensional video file; and
c. computing components coupled to the virtual reality headset and the media store and programmed to:
i. receive from the media store a two-dimensional video file;
ii. automatically identify content adjustment triggers of the two-dimensional video file;
iii. generate a first content from the two-dimensional video file and generate a second content from the two-dimensional video file;
iv. deliver the first content to the first display at a first time; and
v. deliver the second content to the second display at a second time.

2. The system of claim 1 wherein the headset comprises lenses housed in a frame, wherein the frame is coupled to a mobile device and wherein the first and second displays comprise first and second segments of the mobile device display.

3. The system of claim 2 wherein the computing components comprise the computing components of the mobile device.

4. The system of claim 3 wherein the media store is accessed by the computing components over a network.

5. The system of claim 3 wherein the computing components of the mobile device comprise the media store.

6. The system of claim 1 wherein the computer components are programmed to automatically identify content adjustment triggers of the two-dimensional video file by evaluating the change in pixel colors as the pixels refresh.

7. The system of claim 1 wherein the computer components are programmed to generate first content that comprises a first interpolation of frames of the two-dimensional video file and to generate second content that comprises a second interpolation of frames of the two-dimensional video file.

8. The system of claim 1 wherein the second time and first time differ.

9. The system of claim 7 wherein the second time is the same as the first time.

10. The system of claim 7 wherein the second time and first time differ.

11. A computer implemented method for displaying two-dimensional content on a headset system, comprising executing on a processor the steps of:
a. accessing a two-dimensional video file with a computer that is in communication with a first display and a second display;
b. evaluating the two-dimensional file for content adjustment triggers;
c. generating a first content file from the two-dimensional video file;
d. generating a second content file from the two-dimensional video file;
e. delivering the first content file to the first display at a first time; and
f. delivering the second content file to the second display at a second time.

12. The system of claim 11 wherein evaluating the two-dimensional file for content adjustment triggers comprises evaluating the change in individual pixel colors as the pixels refresh.

13. The system of claim 11 wherein the second time and the first time differ.

14. The system of claim 11 wherein the second time and the first time are the same.

15. The system of claim 13 wherein the generated first content file is substantially identical to the generated second content file.

16. A non-transitory computer-readable medium with instructions stored thereon for displaying two-dimensional content on a headset system, that when executed by a processor, perform the steps comprising:
a. accessing a two-dimensional video file with a computer that is in communication with a first display and a second display;
b. evaluating the two-dimensional file for content adjustment triggers;
c. generating a first content file from the two-dimensional video file;
d. generating a second content file from the two-dimensional video file;
e. delivering the first content file to the first display at a first time; and
f. delivering the second content file to the second display at a second time.

17. The system of claim 16 wherein evaluating the two-dimensional file for content adjustment triggers comprises evaluating the change in individual pixel colors as the pixels refresh.

18. The system of claim 16 wherein the second time and the first time differ.

19. The system of claim 16 wherein the second time and the first time are the same.

20. The system of claim 18 wherein the generated first content file is substantially identical to the generated second content file.
